(19) United States
(12) Patent Application Publication
(10) Pub. No.: US 2022/0156555 A1
(43) Pub. Date: May 19, 2022

(54) HIERARCHICAL TIME-SERIES PREDICTION METHOD

(71) Applicants: Inventec (Pudong) Technology Corporation, Shanghai (CN); INVENTEC CORPORATION, Taipei (TW)

(72) Inventors: Davide Burba, Taipei (TW); Trista Pei-Chun CHEN, Taipei (TW)

(21) Appl. No.: 17/132,133

(22) Filed: Dec. 23, 2020

(30) Foreign Application Priority Data
Nov. 18, 2020 (CN) 202011293857.9

(51) Int. Cl. G06N 3/04; G06N 3/08

(52) U.S. Cl. CPC G06N 3/049; G06N 3/08

(57) ABSTRACT

A hierarchical time-series prediction method is adapted to a plurality of reconciled predictions of a plurality of nodes of a hierarchical structure. The plurality of nodes have a plurality of time-series respectively, the plurality of reconciled predictions correspond to the plurality of time-series, the plurality of nodes comprises a plurality of bottom nodes, and the hierarchical time-series prediction method comprises: generating a plurality of individual predictions corresponding to the plurality of time-series respectively by a plurality of predictive models; generating a plurality of bottom-level predictions corresponding to the plurality of bottom nodes according to the plurality of individual predictions and an encoder network; and generating the plurality of reconciled predictions according to the plurality of bottom-level predictions and a decoder associated with the hierarchical structure.

### CROSS-REFERENCE TO RELATED APPLICATIONS

This non-provisional application claims priority under 35 U.S.C. § 119(a) on Patent Application No(s). 202011293857.9 filed in China on Nov. 18, 2020, the entire contents of which are hereby incorporated by reference.

### BACKGROUND

### 1. Technical Field

This disclosure relates to a prediction of time-series, and more particularly to a hierarchical time-series prediction method.

### 2. Related Art

The hierarchical time-series is a collection of time-varying observations organized in a hierarchical structure. The hierarchical time-series often appears in business and economics, where time-varying quantities need to be predicted at different granularity levels. For instance, in the supply chain, forecasts of the demand may be required at a country, city, or store level to organize the logistic. In numerous applications, it is required to produce forecasts for multiple time-series at different hierarchy levels. The independent forecasts typically do not add up properly because of the hierarchical constraints, so a reconciliation step is needed.

Predictions for hierarchical time-series are typically built in two independent stages. First, forecasts are produced for all or some of the time-series. Then, the forecasts are reconciled to enforce the hierarchy constraints. The main methods for reconciling time-series predictions are known as “bottom-up”, “top-down”, “optimal reconciliation”, and “trace minimization”. A common drawback of these methods is that they are not flexible, meaning that they do not allow for a specific metric to be optimized. In real-world forecasting model, it is typically required to minimize a given metric, e.g. the Mean Absolute Scaled Error (MASE) or the Mean Absolute Error (MAE), and the modeling choices depend on the chosen metric.

With the rise of deep learning in the past years, some attempts have been proposed to improve performances and overcome current limitations in the reconciliation setting. These methods exploit the hierarchical structure by imposing soft constraints in the loss function to regularize the training process, improve forecasting performances, and tighten the reconciliation gaps. However, they cannot guarantee an exact reconciliation, i.e. the hierarchy constraints are not satisfied.

### SUMMARY

In view of the above, the present disclosure provides a reconciliation strategy based on an encoder-decoder neural network. The present disclosure is general, flexible, and easy to implement. The present disclosure consistently achieves a better or equal performance than the existing reconciliation methods by applying the present disclosure to the real-world datasets.

According to one or more embodiment of this disclosure, a hierarchical time-series prediction method adapted to a plurality of reconciled predictions of a plurality of nodes of a hierarchical structure, wherein the plurality of nodes have a plurality of time-series respectively, the plurality of reconciled predictions correspond to the plurality of time-series, the plurality of nodes comprises a plurality of bottom nodes, and the hierarchical time-series prediction method comprises: generating a plurality of individual predictions corresponding to the plurality of time-series respectively by a plurality of predictive models; generating a plurality of bottom-level predictions corresponding to the plurality of bottom nodes according to the plurality of individual predictions and an encoder network; and generating the plurality of reconciled predictions according to the plurality of bottom-level predictions and a decoder associated with the hierarchical structure; wherein a number of the plurality of individual predictions is greater than a number of the plurality of bottom-level predictions and is equal to a number of the reconciled predictions; the individual prediction and the reconciled prediction that correspond to one of the plurality of time-series are consecutive in time.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 shows an example of a hierarchical structure;

FIG. 2 is a flowchart of a hierarchical time-series prediction method according to an embodiment of the present disclosure;

FIG. 3 is a schematic diagram of an architecture performing the hierarchical time-series prediction method according to the embodiment of the present disclosure;

FIG. 4A is a schematic diagram of a standard fully-connected network; and

FIG. 4B is a schematic diagram of a shrunk version of a fully-connected network.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

Please refer to FIG. 1, which shows an example of a hierarchical structure. The hierarchical structure has multiple nodes A-G, wherein D-G are bottom-level nodes. Each of nodes A-G corresponds to a time-series Aₜ-Gₜ. The time-series presents, for example, the monthly production of producers in a sequential manner. The hierarchical structure of FIG. 1 shows dependency of these time-series, and the following is a practical example: The factory a have two production lines b and c, wherein the production line b has machines d and e, and the production line c has machines f and g. Time-series Dₜ, Eₜ, Fₜ, and Gₜ indicate monthly production of machines d, e, f, and g respectively. Time-series Bₜ and Cₜ indicate monthly production of production lines b and c respectively. The time-series Aₜ indicates monthly production of factory a. Productions Aₜ-Gₜ of these producer a-g satisfy relations of “Aₜ=Bₜ+Cₜ”, “Bₜ=Dₜ+Eₜ”, and “Cₜ=Fₜ+Gₜ”.

In addition to the above example, multiple time-series can be used, for example, to describe the monthly budgets of various departments in government agencies, the daily temperature and humidity in weather forecasts, and the monthly turnover of various products in a convenience store. The present invention does not particularly limit the application field of the time-series.

The hierarchical structure is configured to represent dependency relations in multiple time-series. Following the previous example: the monthly production of product line b in this month is affected by the monthly productions of machines d and e in this month. Under certain conditions, the monthly production of product line b in this month may be affected by the monthly productions of machines d and e in the past few months. The hierarchical time-series prediction method proposed by the present disclosure may select part or all of the data for calculation to generate the predictions of Aₜ-Gₜ (such as estimated monthly production) and these predictions satisfy the mutual dependence of Aₜ-Gₜ. For example, the sum of the estimated productions of Bₜ and Cₜ does not exceed the estimated monthly production of Aₜ, wherein the data with a large number of dimensions comprise the actual production and expected production of the time series Aₜ-Gₜ in the past.

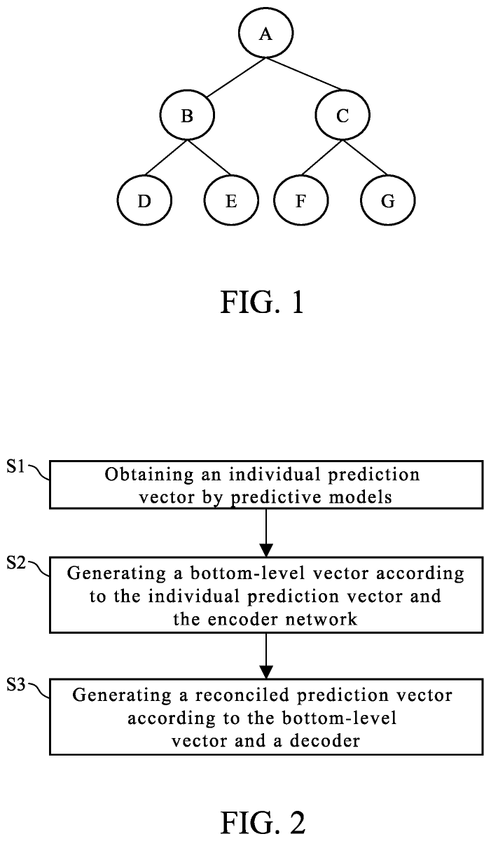

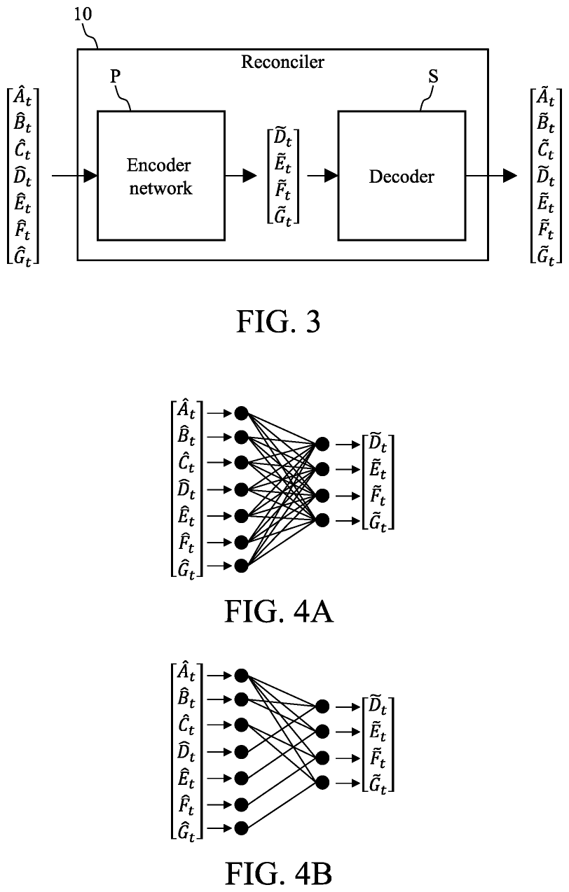

FIG. 2 is a flowchart of a hierarchical time-series prediction method according to an embodiment of the present disclosure. FIG. 3 is a schematic diagram of an architecture performing the hierarchical time-series prediction method according to the embodiment of the present disclosure. In FIG. 3, a plurality of independent predictions is inputted to the reconciler 10. The reconciler 10 comprises a trainable encoder network P and a fixed decoder S. The reconciler 10 outputs a plurality of reconciled predictions corresponding to time-series respectively. The following will describe the implementation of the architecture of FIG. 3 in detail according to the flow of FIG. 2.

Step S1 shows that “obtaining an individual prediction vector by predictive models”. Specifically, the individual prediction vector comprises individual predictions of the plurality of time-series, shown as [ [symbol] , [symbol] , [symbol] , [symbol] , [symbol] , [symbol] , [symbol] ]^{T} in FIG. 3 wherein each of Aₜ, Bₜ, . . . , Gₜ represents a time-series. The present disclosure uses a plurality of predictive models to generate the plurality of individual predictions corresponding to the plurality of time-series respectively. In an embodiment of the present disclosure, each individual prediction of the individual prediction vector is the next prediction of the time-series. For example, [symbol] , [symbol] , . . . , [symbol] are monthly productions of the next month. However, the present disclosure is not limited in the above example. In another embodiment, each of [symbol] , [symbol] , . . . , [symbol] may denotes multiple predictions of consecutive predicting periods (such as the next two months).

In step S1, the predictive model is configured to generate the next prediction of the time-series. This predictive model has been trained before step S1. For example, the present disclosure collects historical predicted productions A_{HP} and historical real productions A_{HR} of factory A in the past few months as the training data of the predictive model regarding the time-series Aₜ.

The present disclosure adopts one of the following two strategies to train predictive models described in step S1. The first strategy uses an independent predictive model for every time-series. The second strategy uses a global predictive model for all of the time-series.

In the first strategy, the present disclosure adopts a linear autoregressive model and takes the lagged time-series values as input. The hyperparameter of the predictive model corresponding to each time-series is adjusted independently in the first strategy. For example, the adjustment of the hyperparameter of the time-series Aₜ does not affect the adjustment of the hyperparameter of the time-series Bₜ. The present disclosure performs a grid search to optimize the number of predictive lagged values in the first strategy.

In the second strategy, for the datasets which present a high number of time-series, such as the dataset with more than 500 time-series, the present disclosure estimates a single global predictive model to forecast all the time-series. This approach exploits the time-series similarities and estimating a complex model. The present disclosure adopts the Light Gradient Boosting (LightGBM) model, taking the scaled lagged values, time-series specific features, and temporal features as inputs. Similarly, the training stage of this predictive model uses historical predicted data and historical real data as the training data. If the predictive model is configured to predict the amount of coke sold in a store, the time-series specific features may use temperature, humidity, or season, etc., and the temporal feature is related to time, the temporal feature could be the number of sunny days in the past month. In this strategy, hyperparameters of the predictive model corresponding to every time-series may be referenced or leveraged mutually. For example, the hyperparameter setting of time-series Cₜ may be identical to the hyperparameter setting of time-series Bₜ. In the second strategy, the present disclosure performs a grid search to optimize the number of leaf nodes of the tree built by LightGBM and the minimum number of observations in each leaf hyperparameters, and keeps the default values for other hyperparameter, wherein said hyperparameters are configured to present the structure and branches of the tree. Once the best configuration is found, the present disclosure keeps multiple models trained during cross-validation in order to validate the parameters of the reconciler 10. The reconciler 10 fixes the predictive model to generate a more accurate prediction according to the hierarchical constraints. The searching time may be reduced by replacing the grid search with a random search.

For both strategies described above, the present disclosure chooses the best hyperparameters combination by performing ten-folds blocked cross-validation, i.e. with validation sets belonging to the same time-window. This validation technique was shown to be effective for time-series tasks.

In real-world, the predictive model is typically required to minimize a given metric, e.g. the Mean Absolute Scaled Error (MASE) or the Mean Absolute Error (MAE), and the modeling choices depend on the chosen metric.

To demonstrate the flexibility of our approach, an embodiment of the present disclosure adopts two kinds of evaluation metrics. The first metric is MASE and the second metric is Mean Logarithm of Absolute Error (MLAE). The present disclosure trains a plurality of predictive model with different loss functions according to this two metrics. For example, MASE is used as the loss function when the metric is MASE, or MLAE is used as the loss function when the metric is MLAE. Note that using the performance metric as a loss function is a convenient and intuitive way.

In another embodiment, the present disclosure does not adopt MASE as the loss function for almost constant time-series so as to avoid unstable predictions. In said embodiment, the loss function is, for example, to scale the errors by one plus the average in-sample naive error.

In further another embodiment, different weights may be set according to the difference value between the prediction value and the real value in the training stage or verification stage of the predictive stage. For example, the predicted error is the product (the result of multiplication) of loss function's output and a first weight if the predicted production is greater than the real production, and the predicted error is the product (the result of multiplication) of loss function's output and a second weight if the predicted production is smaller than or equal to than the real production, wherein the first weight is greater than the second weight. In practice, the inventory rate increases when the production volume is greater than the sales volume. Therefore, the present disclosure generates different predicted error by setting different weights to reflect this actual condition.

In further another embodiment, the present disclosure selects the metric used in the predictive model of every time-series according to the importance of the node in the hierarchical structure. For example, in the FIG. 1, if the node A is more important than nodes D and E, the predictive model of the time-series Aₜ may adopt MASE as the loss function and the predictive models of the time-series Dₜ and Eₜ nay adopt Mean Absolute Error (MAE) as the loss function. On the other hand, if nodes D and E is more important than the node A, the predictive models of the time-series Dₜ and Eₜ may adopt MLAE as the loss function and the predictive model of the time-series Aₜ may adopt MAE as the loss function.

Please refer to FIG. 2. Step S2 shows that “generating a bottom-level vector according to the individual prediction vector and the encoder network”. Specifically, multiple bottom-level predictions are generated according to the plurality of individual predictions generated in step S1 and the encoder network P shown in FIG. 3, and these bottom-level predictions form the bottom-level vector. The number of individual predictions in step S1 is greater than the number of bottom-level predictions in step S2.

In an embodiment of the present disclosure, the encoder network P is such as an encoder matrix configured to map the individual predictions to the bottom-level predictions.

An embodiment of the present disclosure generalizes a (M×N) matrix with a generic function P: R^{N}→R^{M} represented via a neural network, wherein N represents the number of nodes in the hierarchical structure and M represents the number of leaf nodes in the hierarchical structure.

Please refer to FIG. 3 and the example of hierarchical structure shown in FIG. 1. The encoder network P converts the 7-dimension individual prediction vector [ [symbol] , [symbol] , [symbol] , [symbol] , [symbol] , [symbol] , [symbol] ]^{T} into the 4-dimension bottom-level vector [ [symbol] , [symbol] , [symbol] , [symbol] ]^{T}. The bottom-level predictions [symbol] , [symbol] , [symbol] , [symbol] , correspond to D, E, F, and G shown in FIG. 1 respectively.

For the encoder network P of the reconciler 10, the present disclosure uses the feed-forward neural network with Rectified Linear Unit (ReLU) activation functions and sets the size of the output layers to the number of bottom level time-series.

The present disclosure proposes the following two architectures for the implementation of the feed-forward neural network. The first is a standard fully connected network as shown in FIG. 4A. The second is a “shrunk” version of a fully connected network as shown in FIG. 4B. The second architecture allows that the output for a given bottom-level time-series depends only on predictions for itself and its parents in the hierarchy at all levels.

In the fully-connected network shown in FIG. 4A, the reconciled bottom-level prediction [symbol] is influenced by predictions of time-series at all levels, i.e., [symbol] =f( [symbol] , [symbol] , . . . , [symbol] ). In the shrunk case instead, [symbol] depends only on predictions of itself, its parent and its grand-parent, i.e., [symbol] =f( [symbol] , [symbol] , [symbol] ). Since the prediction of node B in FIG. 1 is not affected by predictions of nodes Y and G, the connection between node B and node F and the connection between B and G may be removed from the fully-connected network. The “shrunk” version does not have the same representative power of the fully connected network. However, the shrunk” version of the fully connected network still includes bottom-up, top-down, and middle-out representation spaces, and any mix of them.

Furthermore, for a given number of hierarchy levels, the number of trainable parameters grows with the number of time-series quadratically in the fully connected case and linearly in the shrunk case. To reduce the overfitting risk, the present disclosure adopts the shrunk architecture when the number of time-series is greater than ten times of their length. In addition, the shrunk option can be generally considered as a tunable hyperparameter.

Step S3 shows that “generating a reconciled prediction vector according to the bottom-level vector and a decoder”. Specifically, multiple reconciled predictions are generated according to multiple bottom-level predictions and decoder associated with the hierarchical structure. As shown in FIG. 3, the decoder S takes the bottom-level predictions as input and reconstructs the predictions at all levels. Both the reconciled prediction vector and the individual prediction vector have the same dimensions, i.e., the number of individual predictions in step S1 is identical to the number of reconciled predictions in step S3. The individual prediction and the reconciled prediction that correspond to one of the plurality of time-series are consecutive in time.

Please refer to FIG. 3. the decoder S of an embodiment of the present disclosure is a fixed 0-1 matrix as shown in the following.

$$[ \begin{matrix}1 & 1 & 1 & 1 \\ 1 & 1 & 0 & 0 \\ 0 & 0 & 1 & 1 \\ 1 & 0 & 0 & 0 \\ 0 & 1 & 0 & 0 \\ 0 & 0 & 1 & 0 \\ 0 & 0 & 0 & 1\end{matrix} ]$$

The decoder S converts the 4-dimension bottom-level vector [ [symbol] , [symbol] , [symbol] , [symbol] ]^{T} into the 7-dimension reconciled prediction vector [ [symbol] , [symbol] , [symbol] , [symbol] , [symbol] , [symbol] , [symbol] ]^{T}.

Each element of the reconciled prediction vector corresponds to a prediction. The decoder S could be a linear function or a non-linear function in other embodiment of the present disclosure.

In an embodiment of the present disclosure, the structure of FIG. 3 corresponds to the following equation:

[symbol]

=SP

[symbol]

wherein [symbol] is the individual prediction vector, [symbol] is the reconciled prediction [symbol] vector, S is a 0-1 matrix corresponding to the decoder S, and P is a 0-1 matrix corresponding to the encoder network P. Therefore, for the optimal combination and trace-minimization methods, P is a dense matrix, while for the top-down method, the P matrix is filled with zeros except for the first column. In other word, the architecture proposed in the present disclosure covers conventional methods for predicting hierarchical time-series.

The present disclosure has two main theoretical advantages: generalization and flexibility. The generalization advantage refers to the wide representation space of the proposed model, which covers and extends the conventional prediction methods and allows for non-linear conversion. The flexibility advantage refers to the fact that the present disclosure allows targeting specific performance goals via the choice of a suitable loss function in the training phase. For example, if the target metric is MLAE, the predictive model can use the MLAE as a loss function. Or, if a specific level of the hierarchy is especially concerned, the present disclosure can assign a higher weight to the corresponding loss terms. Similarly, if errors' importance depends on a scale or is asymmetric, the present disclosure can change the loss function accordingly so to optimize for the target. In contrast, conventional methods are simple heuristics (bottom-up, top-down) or minimize the estimated coefficients' errors under different assumptions (optimal-combinations, trace-minimization).

Furthermore, the model proposed in the present disclosure has the practical advantage to be easy-to-implement and accessible to the wide and fast-growing deep learning community, as opposed to complex statistical models such as optimal combination or trace minimization. Furthermore, if the predictive models can be expressed in a deep-learning framework, the present disclosure allows to stack the reconciler network on top of the predictive models and simultaneously train the reconciler and fine-tune the predictive models.

The present disclosure has the following contributions or effects: The proposed reconciliation method is built on top of any predicting methods of input time-series. The proposed easy-to-implement reconciliation method is more general and flexible than existing approaches. It is a framework that include conventional approaches as special cases. It allows different loss functions for different reality considerations

In view of the above, the present disclosure proposes a new exact methodology to reconcile hierarchical time-series predictions based on an encoder-decoder neural network. The encoder is a trainable neural network that takes as input the independent predictions and outputs the bottom-level reconciled predictions. The decoder is a fixed matrix which reconstructs exactly the predictions at all levels using the bottom-level encoded predictions. The present disclosure includes and generalizes the representation space of existing methods. The present disclosure is extremely flexible, and is easy to implement.

What is claimed is:

1. A hierarchical time-series prediction method adapted to a plurality of reconciled predictions of a plurality of nodes of a hierarchical structure, wherein the plurality of nodes have a plurality of time-series respectively, the plurality of reconciled predictions correspond to the plurality of time-series, the plurality of nodes comprises a plurality of bottom nodes, and the hierarchical time-series prediction method comprises:
generating a plurality of individual predictions corresponding to the plurality of time-series respectively by a plurality of predictive models;
generating a plurality of bottom-level predictions corresponding to the plurality of bottom nodes according to the plurality of individual predictions and an encoder network; and
generating the plurality of reconciled predictions according to the plurality of bottom-level predictions and a decoder associated with the hierarchical structure;
wherein a number of the plurality of individual predictions is greater than a number of the plurality of bottom-level predictions and is equal to a number of the reconciled predictions; and
the individual prediction and the reconciled prediction that correspond to one of the plurality of time-series are consecutive in time.

2. The hierarchical time-series prediction method of claim 1, wherein the encoder network is a feed-forward neural network and a plurality of training data of the encoder network comprises a plurality of historical predicted data and a plurality of historical real data.

3. The hierarchical time-series prediction method of claim 1, wherein each of the plurality of predictive models is a linear autoregressive model, and a hyperparameter of each of the plurality of predictive models is adjusted independently in a training stage.

4. The hierarchical time-series prediction method of claim 1, wherein the plurality of predictive models are Light Gradient Boosting models and hyperparameters of the plurality of predictive models are referenced mutually.

5. The hierarchical time-series prediction method of claim 1, wherein the plurality of predictive models are Light Gradient Boosting models when a number of the time-series is greater than a threshold.

6. The hierarchical time-series prediction method of claim 1, wherein a loss function of each of the plurality of predictive models corresponds to a verification metric of the predictive model.

7. The hierarchical time-series prediction method of claim 1, wherein a loss function corresponding to one of the plurality of time-series is Mean Absolute Scaled Error, with said time-series at a high level of the hierarchical structure, and another loss function corresponding to another one of the plurality of time-series is Mean Absolute Error, with said another time-series at a low level of the hierarchical structure.

8. The hierarchical time-series prediction method of claim 1, wherein a loss function corresponding to one of the plurality of time-series is Mean Logarithm of Absolute Error, with said time-series at a low level of the hierarchical structure, and another loss function corresponding to another one of the plurality of time-series is Mean Absolute Error, with said another time-series at a high level of the hierarchical structure.

9. The hierarchical time-series prediction method of claim 1, wherein the predictive model is configured to output a predicted value and a predicted error, wherein
the predicted error is a product of an output of a loss function and a first weight when the predicted value is greater than a real value;
the predicted error is a product of an output of a loss function and a second weight when the predicted value is not greater than a real value; wherein
the first weight is greater than the second weight.

10. The hierarchical time-series prediction method of claim 2, wherein the feed-forward neural network has a fully-connected layer, a fully-connected layer are formed by the plurality of individual predictions and the plurality of bottom-level predictions, and a connection between each of the plurality of individual predictions and each of the plurality of bottom-level predictions is determined according to the hierarchical structure.
